(19) United States
(12) Patent Application Publication
(10) Pub. No.: US 2016/0362025 A1
(43) Pub. Date: Dec. 15, 2016

(54) SEAT WITH MULTIPLE STRAP MECHANISM FOR SECURING A HEADREST

(71) Applicants: Nathan Heisey, Grand Blanc, MI (US); Matthew Larrison, Grand Blanc, MI (US)

(72) Inventors: Nathan Heisey, Grand Blanc, MI (US); Matthew Larrison, Grand Blanc, MI (US)

(73) Assignee: RECARO CHILD SAFETY LLC, Auburn Hills, MI (US)

(21) Appl. No.: 14/739,597

(22) Filed: Jun. 15, 2015

(51) Int. Cl. B60N 2/28; B60N 2/26

(52) U.S. Cl. CPC B60N 2/2851; B60N 2/265

(57) ABSTRACT

A seating assembly includes a seat having a shell, at least two harness straps each having upper portions, and an adjustment mechanism for adjusting the upper portions of each of the harness straps. The adjustment mechanism includes a support member and at least one biasing member. The biasing member exerts a biasing force upon the support member in an upwards direction to adjust the upper portions of the harness straps. The seating assembly also includes first adjuster strap and a first web adjuster, where the harness straps are connected to the first adjuster strap, and the first adjuster strap is selectively secured by the first web adjuster. The seating assembly also includes a second adjuster strap and a second web adjuster. The second adjuster strap is fixedly attached to the seat and wound around the support member, where the second adjuster strap is selectively secured by the second web adjuster.

### BACKGROUND

The disclosure relates generally to a seat having a headrest and, more particularly, to a multiple strap mechanism that secures the headrest in place such that the headrest is substantially prevented from moving in an upwards and a downwards direction.

Child seats typically include two harness straps and a crotch strap, which are used to secure a child to the seat. Each of the harness straps is provided with a slidable tongue, and the crotch strap is provided with a buckle. The tongues of the harness straps are both selectively engaged by a latching mechanism located in the buckle of the crotch strap to secure the child to the seat. The harness straps include corresponding upper ends and lower ends, where the upper ends are typically received by slots located in a backrest of the seat, and the lower ends may be anchored to a seat pan. When the child is secured to the seat, the upper portion of both the harness straps should be positioned at or slightly below the child's shoulders. Various types of adjustment mechanisms currently exist that automatically position the upper portions of the harness straps relative to the child's shoulders.

It should also be appreciated that a child seat may include a headrest. The headrest may be moveable in both an upwards as well as a downwards direction. In a forward-facing child seat during a vehicle impact, crash forces may urge the headrest in the downward direction. In a rearward-facing child seat, during a vehicle impact, crash forces may urge the headrest in the upward direction. Thus, there exists a continuing need in the art for a mechanism that secures the harness straps and as well as the headrest of a child seat.

### SUMMARY

In one embodiment, a seating assembly may include a seat having a shell, at least two harness straps each having upper portions, and an adjustment mechanism for adjusting the upper portions of each of the harness straps. The adjustment mechanism may include a support member and at least one biasing member. The biasing member exerts a biasing force upon the support member in an upwards direction to adjust the upper portions of the harness straps. The seating assembly also includes first adjuster strap and a first web adjuster, where the harness straps are connected to the first adjuster strap, and the first adjuster strap is selectively secured by the first web adjuster. The seating assembly also includes a second adjuster strap and a second web adjuster. The second adjuster strap is fixedly attached to the seat and wound around the support member, where the second adjuster strap is selectively secured by the second web adjuster.

In another embodiment, a forward-facing seating assembly may include a seat having two opposing sides and a shell, an elongated member fixedly attached to the shell, at least two harness straps each having upper portions, and an adjustment mechanism. The first elongated member may extend in a transverse direction between the two opposing sides of the seat. The adjustment mechanism is for adjusting the upper portions of each of the harness straps. The adjustment mechanism may include a support member and at least one biasing member, where the biasing member exerts a biasing force upon the support member in an upwards direction to adjust the upper portions of the harness straps. The seating assembly also includes a first adjuster strap and a first web adjuster, where the harness straps are connected to the first adjuster strap, and the first adjuster strap is selectively secured by the first web adjuster. The seating assembly also includes a second adjuster strap and a second web adjuster. The second adjuster strap is fixedly attached to the elongated member and wound around the support member. The second adjuster strap is selectively secured by the second web adjuster.

Other objects and advantages of the disclosed method and system will be apparent from the following description, the accompanying drawings and the appended claims.

### BRIEF DESCRIPTION OF THE DRAWINGS

FIG. 1 is a front view of the disclosed child seat assembly including harness straps, a first web adjuster strap, and a second web adjuster strap;

FIG. 2 is a front view of the seat shown in FIG. 1, where a seat cover is removed;

FIG. 3 is a perspective of the rear of the seat of FIG. 1, where all of the straps are omitted;

FIG. 4 is a perspective of a headrest shown in FIG. 1;

FIG. 5 is a rear view of the seat, where the straps have been omitted;

FIG. 6 is an enlarged view of a single flange portion of a support member and two central guide ribs shown in FIG. 5;

FIG. 7 is an enlarged view of a central portion of two support member and two centrally located guide ribs shown in FIG. 5;

FIG. 8 is a perspective rear view of the seat and the harness straps, the first web adjuster strap, and the second web adjuster strap;

FIG. 9 is an illustration of a bottom surface of the seat shown in FIG. 1; and

FIG. 10 is an illustration of the seat shown in FIG. 1, where the seat cover and the headrest have been removed.

### DETAILED DESCRIPTION

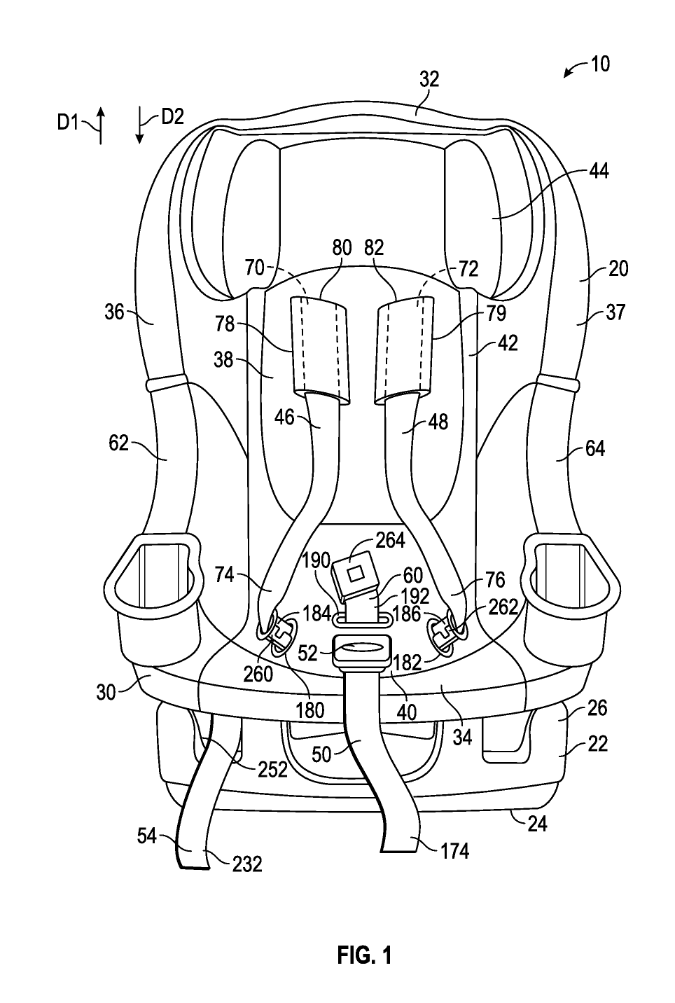

As shown in FIG. 1, the disclosed child seat assembly, generally designated 10, may include a seat 20 and a base 22. The base 22 may include a lower surface 24 and an upper portion 26. The base 22 may be installed on a vehicle seat (not illustrated), where the lower surface 24 of the base 22 rests against the vehicle seat. The upper portion 26 of the base 22 may selectively receive a bottom portion 30 of the seat 20.

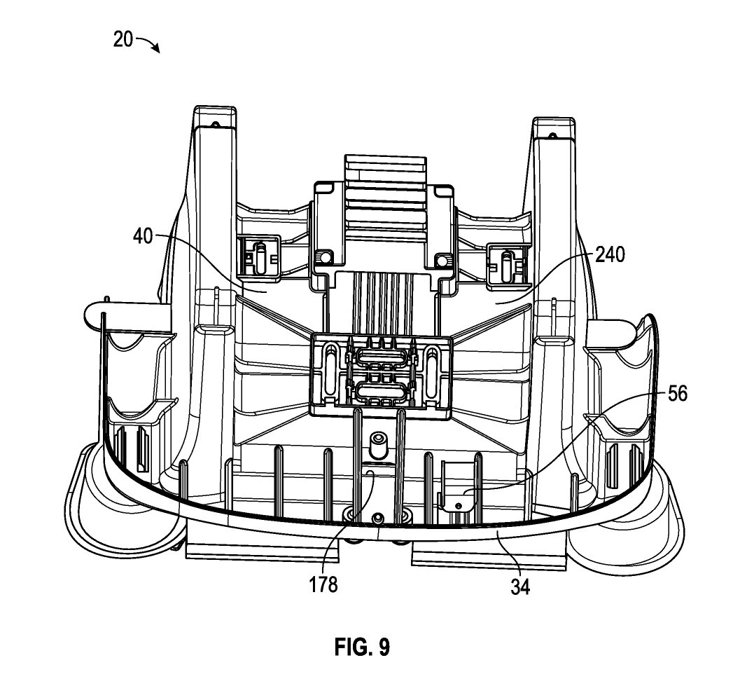

The seat 20 may have a head end 32, a foot end 34, two opposing sides 36, 37, a back support 38, and a seat pan 40. The two sides 36, 37 of the seat 20 may be generally parallel with one another and extend between the head end 32 and the foot end 34. The seat 20 may also include a cover 42, a headrest 44, two harness straps 46, 48, a first adjuster strap 50, a first web adjuster 52, a second web adjuster strap 54, a second web adjuster 56 (the second web adjuster 56 is visible in FIG. 9), a crotch strap 60, and two arm rests 62, 64. The headrest 44 may be located at the head end 32 of the seat 20. The headrest 44 may be moveable in an upward direction D1 towards the head end 32 of the seat 20, and a downward direction D2 towards the bottom portion 30 of the seat 20. The arm rest 62 may be located along the side 36 and the armrest 64 may be located along the side 37 of the seat 20. The crotch strap 60 may be located on the seat pan 40 of the seat 20. Although the seat 20 is illustrated as a child seat received by the base 22, it is to be understood that the base 22 may be omitted in another embodiment.

In one embodiment, the seat 20 may be any type of child seat for securing a child or an infant in a vehicle such as, for example, an infant seat, a convertible seat, or a combination seat. However, it is to be understood that the seat 20 is not limited to child seating used in a vehicle, and may be used in any type of juvenile product such as, for example, a booster seat or a high chair seat. Moreover, in an alternative embodiment, the seat 20 may be configured to secure an adult, such as a passenger seat in a motor vehicle or an aircraft.

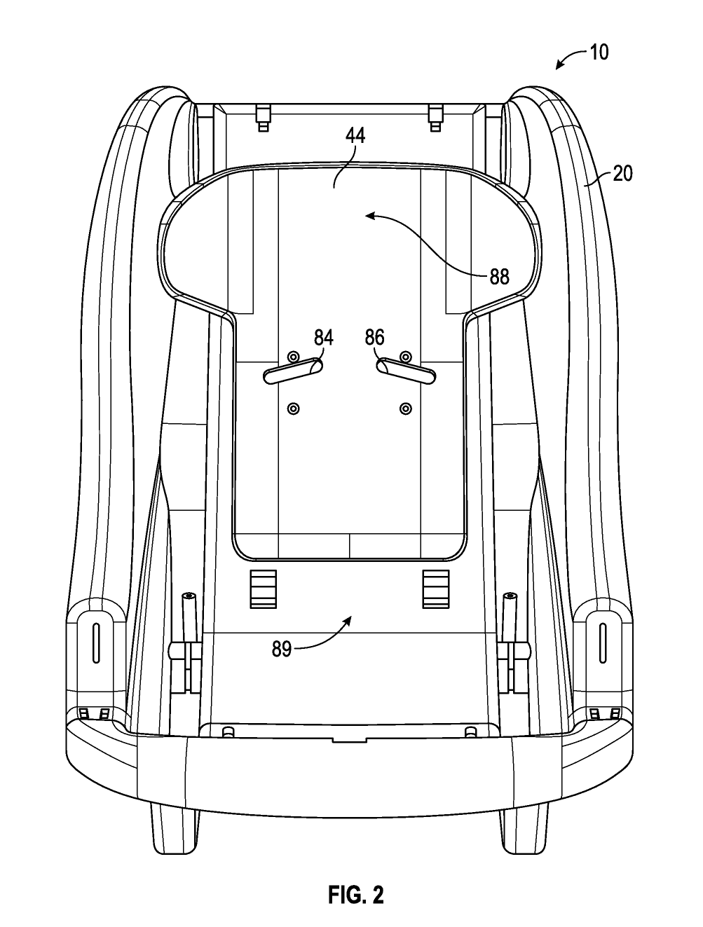

The harness straps 46, 48 may include corresponding upper portions 70, 72 (shown in phantom line) and corresponding lower portions 74, 76. The upper portions 70, 72 of the harness straps 46, 48 may be received by corresponding tubular pads 78, 79 located along the back support 38. The upper portions 70, 72 of the harness straps 46, 48 may each pass through respective slits 80, 82 located in the seat cover 42 on the back support 38. Referring to FIG. 2, the cover 42 of the seat 20 has been removed, thereby revealing a shell 88 of the headrest 44 and a shell 89 of the seat 20. The shell 88 may have two openings 84, 86 that correspond to one of the slits 80, 82 in the seat cover 42 (shown in FIG. 1). Referring to FIGS. 1-2, the upper portions 70, 72 of the harness straps 46, 48 may also pass through the respective openings 84, 86 located in the headrest 44.

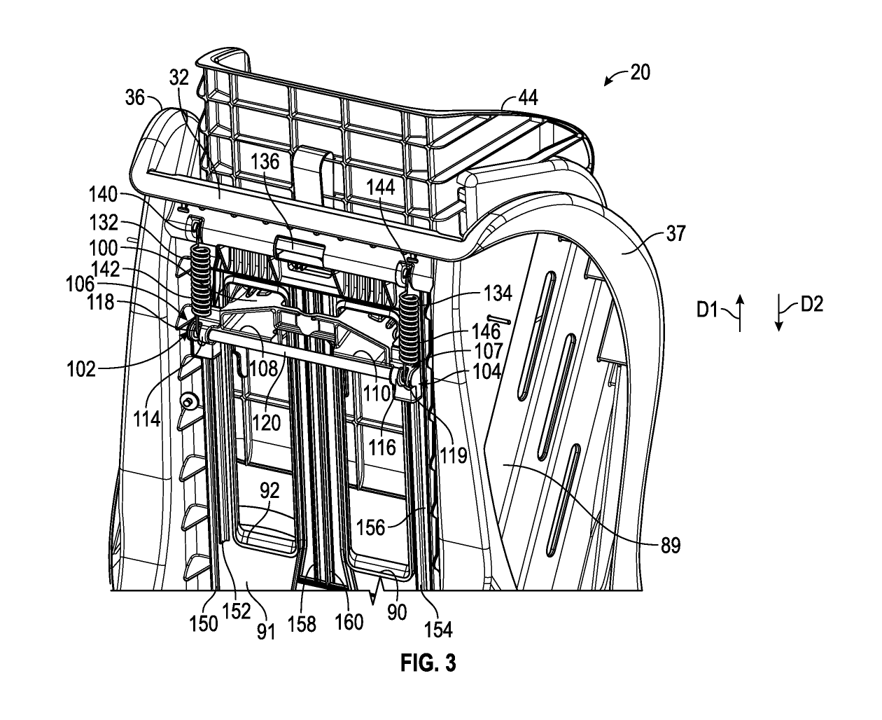

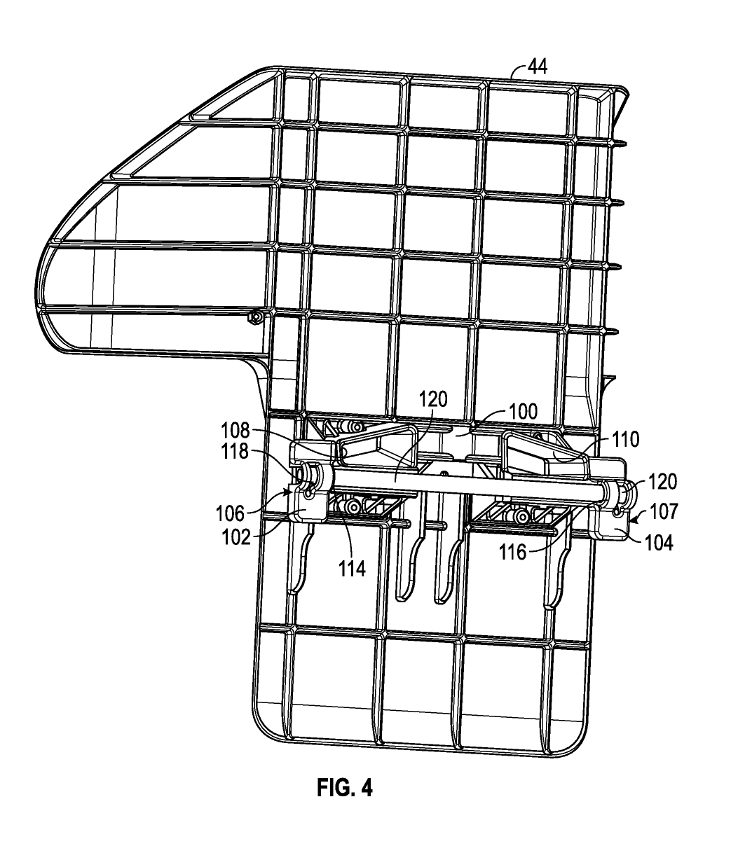

Referring to FIGS. 1-3, a rear surface 91 of the seat 20 may have two vertically extending slots 90, 92 that correspond to the openings 84, 86 in the shell 88 of the headrest 44. The two upper portions 70, 72 of the harness straps 46, 48 (shown in FIG. 1) may pass through the two slots 90, 92 in the seat 20. Referring to both FIGS. 3-4, a support member 100 may be connected to the headrest 44. Thus, as the headrest 44 moves in the upward direction D1 and the downward direction D2, the support member 100 may move in concert along with the headrest 44. Two flange portions 102, 104 may be located on opposing ends 106, 107 of the support member 100. The support member 100 may also include two openings 108, 110, which correspond to the openings 84, 86 located in the headrest 44 (shown in FIG. 2). The two upper portions 70, 72 of the harness straps 46, 48 (shown in FIG. 1) may pass through the two openings 108, 110 of the support member 100. In one embodiment, the support member 100 may be used to secure a rod 120. Although a rod is illustrated, any other type of elongated support member may be used as well. The support member 100 may define two sleeves or receptacles 114, 116 that are located on the opposing ends 106, 107 of the support member 100. Each receptacle sleeve 114, 116 of the support member 100 may be shaped to receive one of the ends 118, 119 of the rod 120.

Referring to FIG. 3, two biasing members or springs 132, 134 may be connected to both the seat 20 and the support member 100. Specifically, the spring 132 may be located adjacent the side 36 of the seat 20, and may include a first end 140 attached to the head end 32 of the seat 20 and a second end 142 attached to the support member 100. More specifically, the first end 140 of the spring 132 may be connected to an elongated member 136. As explained in greater detailed below, the elongated member 136 may be attached to the shell 89 of the seat 20, and extends in a transverse direction along the head end 32 of the seat 20. The spring 134 may be located adjacent the side 37 of the seat 20, and may include a first end 144 attached to the head end 32 of the seat 20 and a second end 146 attached to the support member 100. More specifically, the first end 144 of the spring 132 may also be connected to the elongated member 136 as well. The springs 132, 134 may exert a biasing force on the support member 100 in a generally upwards direction (e.g., in the upward direction D1).

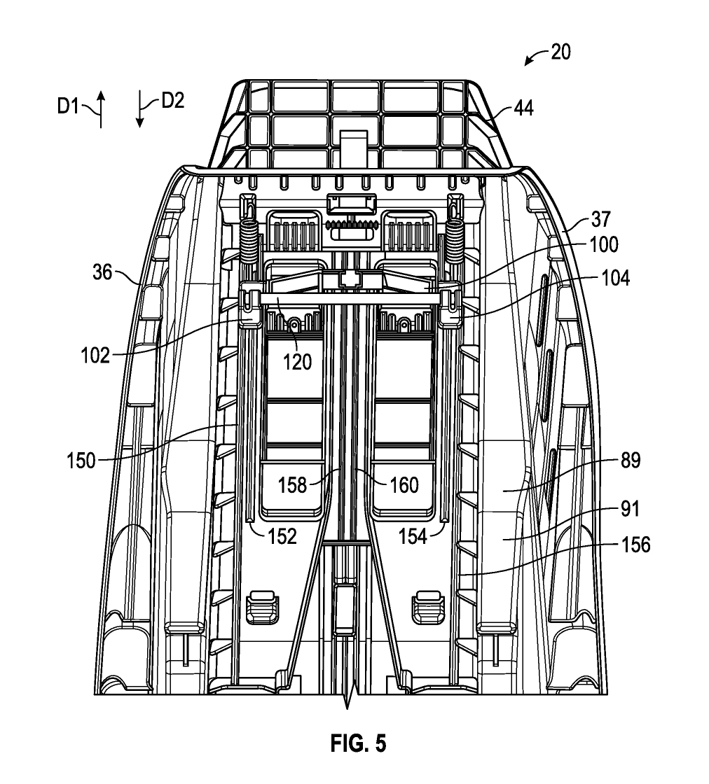

Referring to both FIGS. 3 and 5, the rear surface 91 of the seat 20 may also include substantially vertical guide ribs 150, 152, 154, and 156 that project outwardly from the rear surface 91 of the seat 20. The guide ribs 150, 152 may be located adjacent the side 36 of the seat 20, and guide ribs 154, 156 may be located adjacent the side 37 of the seat 20. As seen in FIG. 5, the guide ribs 150 and 156 extend further downwardly along the rear surface 91 of the seat 20 when compared to the guide ribs 152, 154. Two centrally located and generally vertical guide ribs 158, 160 may also be located along the rear surface 91 of the seat 20. Those skilled in the art will appreciate that although six guide ribs 150, 152, 154, 156, 158, and 160 are illustrated, the rear surface 91 of the seat 20 may include any number of guide ribs depending on the requirements of a specific application.

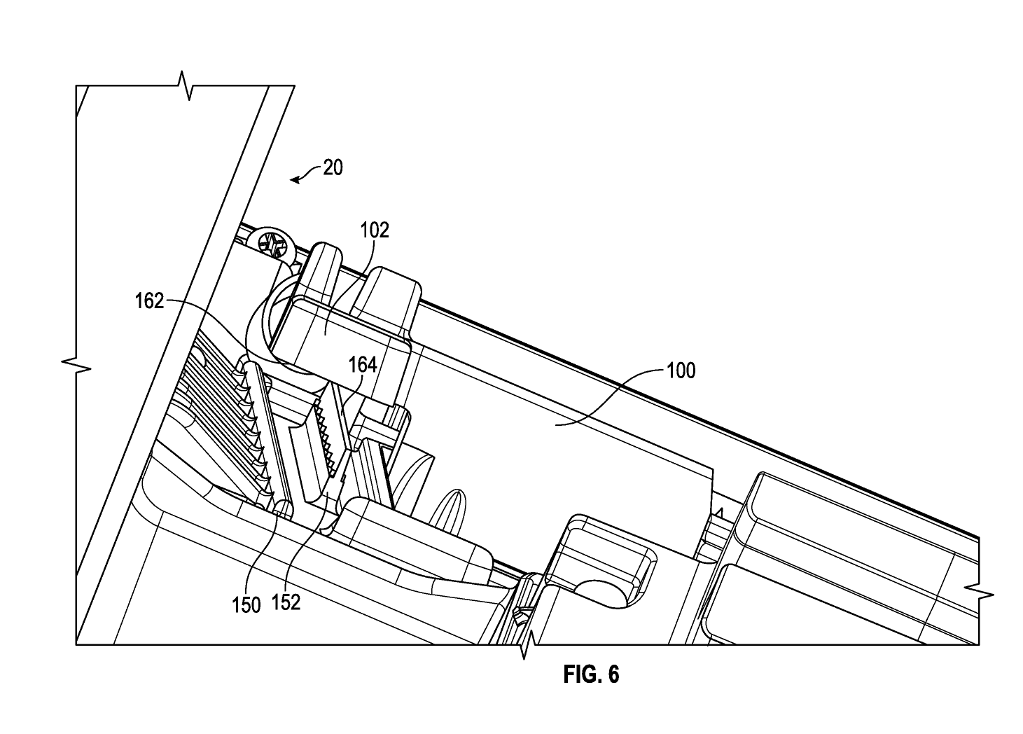

FIG. 6 is an enlarged view of one of the flange portions 102 of the support member 100 as well as the guide ribs 150, 152 located adjacent to the side 36 of the seat 20. Referring to both FIGS. 5-6, the innermost guide rib 152, which is located closer to the centrally located guide ribs 158, 160 than the guide rib 150, may be used to provide guidance to the headrest 44. Specifically, the innermost guide rib 150 may be used to ensure generally linear motion of the headrest 44 in the upward direction D1 and the downward direction D2. As seen in FIG. 6, an uppermost surface 164 of the innermost guide rib 150 may abut or make contact with a rear surface 162 of the support member 100, at the flange portion 102. Thus, as the headrest 44 travels in either the upward direction D1 or the downward direction D2, and if the support member 100 starts to shift in a non-linear direction towards the guide rib 152, the rear surface 162 of the support member 100 may abut against the uppermost surface 164 of the guide rib 152, thereby re-directing motion of the support member 100 in a linear direction.

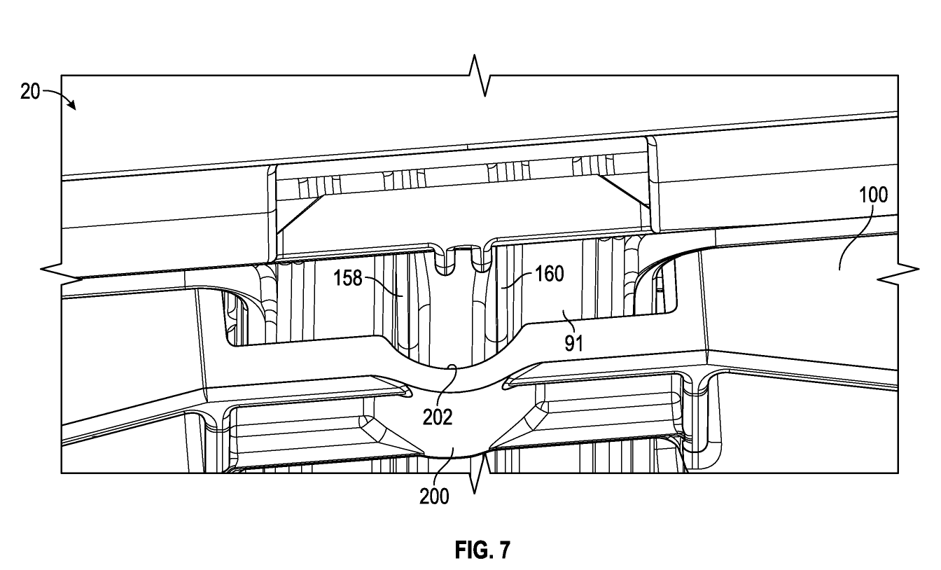

Referring to both FIGS. 5 and 7, the two centrally located guide ribs 158, 160 located along the rear surface 91 of the seat 20 may also be used to ensure generally linear motion of the headrest 44 in the upward direction D1 and the downward direction D2. FIG. 7 is an enlarged view of a portion of the support member 100 and the guide ribs 158, 160. As seen in FIG. 7, a central portion 200 of the support member 100 may define a recess or cutout 202. The cutout 202 may include a generally semi-circular profile, and is shaped to surround the two centrally located guide ribs 158, 160 located along the rear surface 91 of the seat 20. As the headrest 44 (FIG. 1) travels in either the upward direction D1 or the downward direction D2, and if the support member 100 starts to shift in a direction generally transverse to the guide ribs 158, 160, the support member 100 may abut against one or both of the guide ribs 158, 160 along the cutout 202, thereby re-directing motion of the support member 100 in a linear direction.

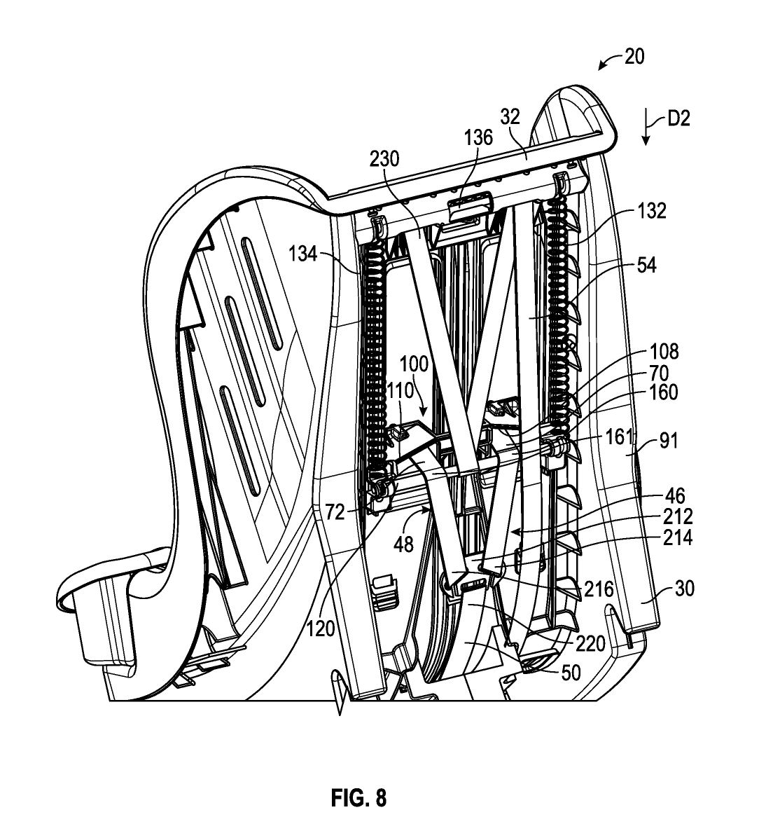

FIG. 8 is an illustration of the rear surface 91 of the seat 20, as well as the upper portions 70, 72 of the harness straps 46, 48 and the second web adjuster strap 54. As seen in FIG. 8, the upper portions 70, 72 of the harness straps 46, 48 may pass through the two openings 108, 110 in the support member 100. A portion of each of the harness straps 46, 48 may rest against the rod 120. Specifically, a portion 160 of the harness strap 46 may rest against the rod 120, and a portion 161 of the harness strap 48 may rest against the rod 120. The harness straps 46, 48 may extend in a generally downward direction from the rod 120 towards the bottom portion 30 of the seat 20. A t-bar 212 may be located along the bottom portion 30 of the seat 20. Both of the harness straps 46, 48 may be secured to the t-bar 212 at their respective ends. Specifically, a first end 214 of the harness strap 46 and a first end 216 of the harness strap 48 may both be received and secured to the t-bar 212. The t-bar 212 also may receive and secure a first end 220 of the first adjuster strap 50. The t-bar 212 may be used to connect the harness straps 46, 48 to the first adjuster strap 50. Although a t-bar is shown in FIG. 8, it is understood that any type of securing device may be used to receive and secure the harness straps 46, 48 to the first adjuster strap 50.

Continuing to refer to FIG. 8, the second web adjuster strap 54 may include a first end 230 as well as a second end 232 (visible in FIG. 1). The first end 230 of the second web adjuster strap 54 may be fixedly attached to the seat 20 at the elongated member 136 (the attachment between the second web adjuster strap 54 and the elongated member 136 is not visible in FIG. 8). The second web adjuster strap 54 may extend in the downwards direction D2, towards the bottom portion 30 of the seat 20 from the first end 230, and wraps around the rod 120. As seen in FIG. 8, the second web adjuster strap 54 may be wound around the rod 120 in a V-shaped configuration, however it is to be understood that this illustration is merely exemplary in nature and the second web adjuster strap 54 may be wound around the rod 120 in a variety of other configurations as well. Moreover, it should also be appreciated that in one embodiment, the rod 120 may be omitted. Instead, the second web adjuster strap 54 may be wound around another feature that is connected to the the support member 100 or the headrest 44. The second web adjuster strap 54 may then extend in the upwards direction D1, back towards the head end 32 of the seat 20. The second web adjuster strap 54 may then wrap around the elongated member 136 (the wrapping of the second web adjuster strap 54 around the elongated member 136 is not visible in FIG. 8), and then extends downwardly towards the bottom portion 30 of the seat towards to second web adjuster 56 (shown in FIG. 9).

Turning now to FIG. 9, which is a bottom view of the seat 20, the second web adjuster strap 54 may pass through the second web adjuster 56 (the second web adjuster strap 54 is not shown in FIG. 9). The second web adjuster 56 may be positioned along a bottom surface 240 of the seat 20, along the seat pan 40. Referring to both FIGS. 1 and 9, The second web adjuster strap 54 may then extend towards the towards the foot end 34 of the seat 20. The second end 230 of the second web adjuster strap 54 passes through an opening 252 located within the base 22 (FIG. 1). Operation of the second web adjuster 56 allows the second adjuster strap 54 to be loosened or tightened. The second web adjuster 56 may be used to selectively secure the second adjuster strap 54 in place.

Referring to FIGS. 1 and 8-9, the first adjuster strap 50 may also extend along the bottom surface 240 of the seat 20 towards the foot end 34 of the seat 20. A second end 174 of the first adjuster strap 50 may pass through an opening 178 located at the foot end 34 of the seat 20, and may be received through the first web adjuster 52 (shown in FIG. 1). Operation of the first web adjuster 52 allows the first adjuster strap 50 to be loosened or tightened, which in turn results in the loosening or tightening of the harness straps 46, 48. The first web adjuster 52 may be used to selectively secure the first adjuster strap 50 in place.

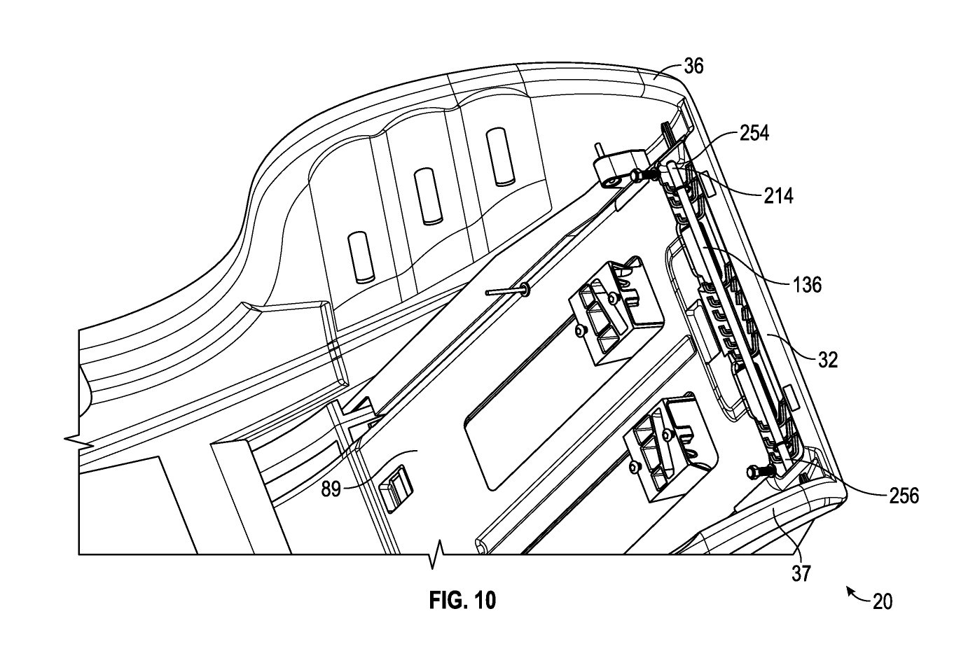

FIG. 10 is a perspective view of the seat 20, where the headrest 44 has been removed in order to view the elongated member 136. As seen in FIG. 10, the elongated member 136 extends in a transverse direction of the seat 20 between the two opposing sides 36, 37. The elongated member 136 may be fixedly attached to the seat 20, and may be used to secure and position the second web adjuster strap 54 (FIG. 8). Specifically, the elongated member 136 includes two opposing ends 254, 256, where a first end 254 of the elongated member 136 is secured at the side 36 of the shell 89, and a second end 256 of the elongated rod 136 is secured at the side 37 of the shell 89. The elongated member 136 may be, for example, a rod having a generally cylindrical shape, however it is to be understood that the disclosure is not limited to a rod. Indeed, the elongated member 136 may be any generally elongated structure that extends in a transverse direction along the head end 32 of the seat 20.

Referring back to FIG. 1, the lower portions 74, 76 of the harness straps 46, 48 may each be received by respective openings 180, 182 located along the seat cover 42 at the seat pan 40. A second end 184 of the harness strap 46 and a second end 186 of the harness strap 48 may both be fixedly attached to the shell 89 of the seat 20 (shown in FIG. 3). The crotch strap 60 may also be received by an opening 190 located along the of the seat cover 42 at the seat pan 40. An end 192 (shown in FIG. 5) of the crotch strap 60 may be fixedly attached to the shell 89 of the seat 20 (shown in FIG. 3). The harness straps 46, 48 may each include respective buckle tongues 260, 262. The buckle tongues 260, 262 may be slidably mounted on one of the harness straps 46, 48. The crotch strap 60 may include a buckle 264 that selectively engages both the buckle tongues 260, 262.

Referring to FIGS. 1-3, the headrest 44, the support member 100, the rod 120, and the springs 132, 134 may define an adjustment mechanism of the seat 20 for positioning the harness straps 46, 48 at or below a child's shoulders. For example, once a child is placed in the seat 20, an adult may then position the harness straps 46, 48 over the arms and shoulders of the child. Referring to FIGS. 1 and 8-9, the second end 174 of the first adjuster strap 50 may then be pulled through the first web adjuster 52. Pulling the first adjuster strap 50 through the first web adjuster 52 may in turn pull the harness straps 46, 46 taut, thus positioning the upper portions 70, 72 of the harness straps 46, 48 at or below the child's shoulders.

Referring specifically to FIGS. 1 and 8, the first adjuster strap 50 may be urged in the downward direction D2 when the second end 174 (FIG. 1) of the first adjuster strap 50 is pulled. The harness straps 46, 48, which are connected to the first adjuster strap 50 by the t-bar 212, may also be urged in the downward direction D2, and eventually pulled taut. Continuing to pull on the second end 174 of the first adjuster strap 50 once the harness straps 46, 48 are taut causes the upper portions 70, 72 of the harness straps 46, 48 to exert a downward force on the support member 100 and the headrest 44. The downward force may urge the headrest 44 and the support member 100 in the downward direction D2. As the headrest 44 and the support member 100 are urged in the downward direction D2, the springs 132, 134 may expand.

The second end 174 of the first adjuster strap 50 may continue to be pulled, thereby causing the headrest 44 to move in the downward direction D2 until the upper portions 70, 72 of the harness straps 46, 48 abut against the child's shoulders. Thus, the headrest 44, the support member 100, the rod 120, and the springs 132, 134 may define the adjustment mechanism of the seat 20 to position the harness straps 46, 48 at or below a child's shoulders. Once the upper portions 70, 72 of the harness straps 46, 48 abut against a child's shoulders, the first web adjuster 52 may engage the first adjuster strap 50 in order to secure the first adjuster strap 50 in place. When the first adjuster strap 50 is secured by the first web adjuster 52, the support member 100 may be held in a stationary position, and the headrest 44 may be substantially unable to move in the upward direction D1.

It is to be understood that if the seat 20 is a rearward-facing seat (i.e., the seat 20 faces rearward when positioned in a vehicle), then only the first web adjuster 52 may be required to secure the headrest 44 of the seat 20. However, as explained below, if the seat 20 is a forward-facing seat (i.e., the seat 20 faces forward when positioned in a vehicle), then a user may also may also utilize the second adjuster strap 54 in order to secure the headrest 44. Specifically, the second adjuster strap 54 may prevent the headrest 44 from substantially moving in the downward direction D2. It is to be understood that the second adjuster strap is usually only needed to secure the headrest 44 when the seat 20 is in a forward-facing position because during a vehicle impact, crash forces may urge the headrest 44 in the downward direction D2.

Referring to FIGS. 1, 8 and 9, after the first adjuster strap 50 is secured by the first web adjuster 52, a user may then pull on the second end 232 of the second adjuster strap 54 through the second web adjuster 56. The second adjuster strap 54 may continue to be pulled through the second web adjuster 56 until the second adjuster strap 54 is wound tautly around the around the rod 120 (seen in FIG. 8). Once the second adjuster strap 54 is wound tautly around the rod 120, then the second adjuster strap 54 is secured by the second web adjuster 56. The headrest 44 is now substantially unable to move in either the upward direction D1 and the downward direction D2.

Referring generally to the figures, the disclosed child seat assembly may secure the headrest such that movement is restricted in both the upwards as well as the downwards direction. For example, if a user positions the seat in the forward-facing position, the second web adjuster may secure the second web adjuster strap such that the headrest is unable to shift or move in the downwards direction during vehicle impact. Accordingly, the second web adjuster and the second web adjuster strap provide a relatively inexpensive, cost-effective approach for allowing the disclosed seat assembly to be used in the forward-facing position.

While the forms of apparatus and methods herein described constitute preferred aspects of this disclosure, it is to be understood that the disclosure is not limited to these precise forms of apparatus and methods, and the changes may be made therein without departing from the scope of the disclosure.

What is claimed is:

1. A seating assembly, comprising:
a seat having a shell;
at least two harness straps each having upper portions;
an adjustment mechanism for adjusting the upper portions of each of the harness straps, the adjustment mechanism including a support member and at least one biasing member, wherein the biasing member exerts a biasing force upon the support member in an upwards direction to adjust the upper portions of the harness straps;
a first adjuster strap and a first web adjuster, wherein the harness straps are connected to the first adjuster strap, and the first adjuster strap is selectively secured by the first web adjuster; and
a second adjuster strap and a second web adjuster, the second adjuster strap fixedly attached to the seat and wound around the support member, wherein the second adjuster strap is selectively secured by the second web adjuster.

2. The seating assembly of claim 1, further comprising an elongated member fixedly attached to the shell, wherein the elongated member extends in a transverse direction between two opposing sides of the seat.

3. The seating assembly of claim 2, wherein an end of the second adjuster strap is secured to the elongated member.

4. The seating assembly of claim 2, wherein the second adjuster strap is wound around the support member in a V-shaped configuration.

5. The seating assembly of claim 2, wherein the biasing member includes a first end and a second end, and wherein the first end of the biasing member is connected to the elongated member and the second end of the biasing member is connected to the support member.

6. The seating assembly of claim 1, wherein the seat includes a seat pan, and wherein the second web adjuster is positioned along a bottom surface of the seat pan.

7. The seating assembly of claim 1, wherein the seat further includes a headrest, and wherein the headrest is moveable in the upwards direction and a downwards direction.

8. The seating assembly of claim 7, wherein if the first adjuster strap is secured by the first web adjuster, then the headrest is substantially unable to move in the upwards direction.

9. The seating assembly of claim 7, wherein if the second adjuster strap is secured by the second web adjuster, then the headrest is substantially unable to move in the downwards direction.

10. The seating assembly of claim 1, wherein the seating assembly is a convertible seat.

11. The seating assembly of claim 1, wherein the seating assembly is a forward-facing seat.

12. The seating assembly of claim 1, wherein the seat defines a rear surface, and wherein at least one rib extends in a substantially vertical direction along the rear surface of the seat.

13. A forward-facing seating assembly, comprising:
a seat having two opposing sides and a shell;
an elongated member fixedly attached to the shell, wherein the first elongated member extends in a transverse direction between two opposing sides of the seat;
at least two harness straps each having upper portions;
an adjustment mechanism for adjusting the upper portions of each of the harness straps, the adjustment mechanism including a support member and at least one biasing member, wherein the biasing member exerts a biasing force upon the support member in an upwards direction to adjust the upper portions of the harness straps;
a first adjuster strap and a first web adjuster, wherein the harness straps are connected to the first adjuster strap, and the first adjuster strap is selectively secured by the first web adjuster; and
a second adjuster strap and a second web adjuster, the second adjuster strap fixedly attached to the elongated member and wound around the support member, wherein the second adjuster strap is selectively secured by the second web adjuster.

14. The forward-facing seating assembly of claim 13, wherein the second adjuster strap is wound around the support member in a V-shaped configuration.

15. The forward-facing seating assembly of claim 13, wherein the biasing member includes a first end and a second end, and wherein the first end of the biasing member is connected to the elongated member and the second end of the biasing member is connected to the support member.

16. The forward-facing seating assembly of claim 13, wherein the seat includes a seat pan, and wherein the second web adjuster is positioned along a bottom surface of the seat pan.

17. The forward-facing seating assembly of claim 13, wherein the seat further includes a headrest, and wherein the headrest is moveable in the upwards direction and a downwards direction.

18. The forward-facing seating assembly of claim 17, wherein if the first adjuster strap is secured by the first web adjuster, then the headrest is substantially unable to move in the upwards direction.

19. The forward-facing seating assembly of claim 17, wherein if the second adjuster strap is secured by the second web adjuster, then the headrest is substantially unable to move in the downwards direction.

20. The forward-facing seating assembly of claim 13, wherein the forward-facing seating assembly is a convertible seat.
